(19) United States
(12) Patent Application Publication
(10) Pub. No.: US 2019/0224962 A1
(43) Pub. Date: Jul. 25, 2019

(54) Ink Circuit of an Inking Unit of a Flexographic or Gravure Printing Press

(71) Applicant: Windmöller & Hölscher KG, Lengerich (DE)

(72) Inventors: Andreas Ihme, Lengerich (DE); Lutz Telljohann, Lengerich (DE)

(21) Appl. No.: 15/750,615

(22) PCT Filed: Aug. 10, 2016
(86) PCT No.: PCT/EP2016/069091

§ 371 Date: Feb. 6, 2018

(30) Foreign Application Priority Data
Aug. 10, 2015 (DE) 10 2015 010 126.9

(51) Int. Cl. B41F 31/08; B41F 5/24; B41F 9/00

(52) U.S. Cl. CPC B41F 31/08; B41F 9/00; B41F 5/24

(57) ABSTRACT

The invention relates to an ink circuit of an inking unit of a flexographic or gravure printing press. In order to reduce the changeover costs in relation to the ink circuit of an inking unit of a flexographic or gravure printing press, an ink circuit of an inking unit of a flexographic or gravure printing press is provided, wherein the inking unit has an ink inflow for providing ink which is ready for printing and an ink outflow for transporting away excess ink, wherein the ink inflow is operated by an inflow pump and the ink outflow is operated by an outflow pump, and wherein the outflow pump is a pump which is driven by an electric motor.

The invention relates to an ink circuit of an inking unit of a flexographic or gravure printing press.

Inks used for flexographic and gravure printing presses for the most part contain solvents which necessitate special explosion protection in accordance with the European Union's so-called ATEX directives (ATEX being an acronym of the two French terms ATmospheres EXplosibles). Therefore, air-driven pumps, primarily double diaphragm pumps or peristaltic pumps, have been used for these ink circuits until now.

A generic ink circuit that comprises an air-driven double diaphragm pump is known, for example, from German patent specification DE 102 25 681 B4. Additionally, a generic ink circuit that comprises an air-driven peristaltic pump is known from German patent application DE 195 15 621 A1.

In flexographic and gravure printing, a trend can be seen towards increasingly shorter printing jobs, and therefore the costs of changeovers on the printing press between individual printing jobs are becoming increasingly more significant.

It is therefore the aim of the present invention to reduce the changeover costs with regard to the ink circuit of an inking unit of a flexographic or gravure printing press.

This aim is achieved by the features of claim 1.

Additional embodiments are provided by the features of subclaims 2-6.

The ink circuit according to the present invention of an inking unit of a flexographic or gravure printing press accordingly comprises the following features: the inking unit has an ink inflow for providing ink which is ready for printing and an ink outflow for transporting away excess ink, wherein the ink inflow is operated by an inflow pump and the ink outflow is operated by an outflow pump, and wherein the outflow pump is a pump which is driven by an electric motor.

Inks used in the field of flexographic and gravure printing generally contain solvents (e.g., ethanol in flexographic printing, and ethanol or ethyl acetate in gravure printing) which necessitate special measures for explosion protection. The equipment protection level pursuant to the aforementioned ATEX directives therefore, in the area of the ink circuit, is classified into the so-called “Zone 0,” which is defined as an area in which an explosive atmosphere consisting of a mixture with air of dangerous substances in the form of gas, vapor or mist is present continuously or for long periods or frequently.

Printing ink in an ink circuit of a flexographic or gravure printing press is therefore typically conveyed using pneumatically operated diaphragm pumps.

To a person skilled in the art it is therefore surprising that the present invention, in contrast to the prior art, proposes that a pump driven directly by an electric motor be used as an outflow pump.

According to a preferred embodiment of the invention, provision is made for the inflow pump, also, to be a pump driven by an electric motor.

It is an essential finding of the invention, therefore, that, under certain conditions, a pump which is driven by an electric motor can indeed be employed as an outflow pump and/or inflow pump. One pump which meets these requirements very well is a so-called annular piston pump. Such a pump has a bellows of stainless steel which, in order to achieve the pumping action, is moved by an electric motor. Employing such an annular piston pump provides a multitude of advantages:
Compared to a pneumatically operated diaphragm pump, the annular piston pump can be operated with significantly less energy. For instance, operating a diaphragm pump in the described application requires approximately 1 kW of power, whereas operating an annular piston pump requires only approximately 200 W of power.
Compared to a pneumatically operated membrane pump, the sound emission of an annular piston pump is significantly lower.
Furthermore, the amount of ink lost during an ink change is significantly less with an annular piston pump than with a pneumatically operated diaphragm pump, because the annular piston pump has a smaller dead volume. This means that the changeover times between two printing jobs become shorter, thereby reducing the overall printing costs.
The delivery rate of an annular piston pump can be controlled in a very targeted manner, which greatly expands the possibilities for controlling the printing ink within the ink circuit. For instance, the pump can be controlled via the torque, the torque being a function of the volumetric flow rate and the viscosity of the ink. Conversely, it is also possible to determine the viscosity of the ink conveyed by the pump according to the motor state of the electric motor (torque, motor current), without requiring for this purpose a separate sensor for measuring the viscosity.
Lastly, maintenance of an annular piston pump is significantly more cost-effective as well, because an annular piston pump primes from dry, is dry-run capable, and has no dynamic seals.

According to a further preferred embodiment, provision is made for a heat exchanger to be connected downstream of the annular piston pump, to cool the ink. Since printing ink heats up as it passes through the annular piston pump, the heat exchanger prevents the printing ink from degrading as a result of being heated.

According to a further preferred embodiment, provision is made for the electric motor to be an asynchronous motor.

Further details and advantages of the invention will be described with reference to the appended drawing, in which:

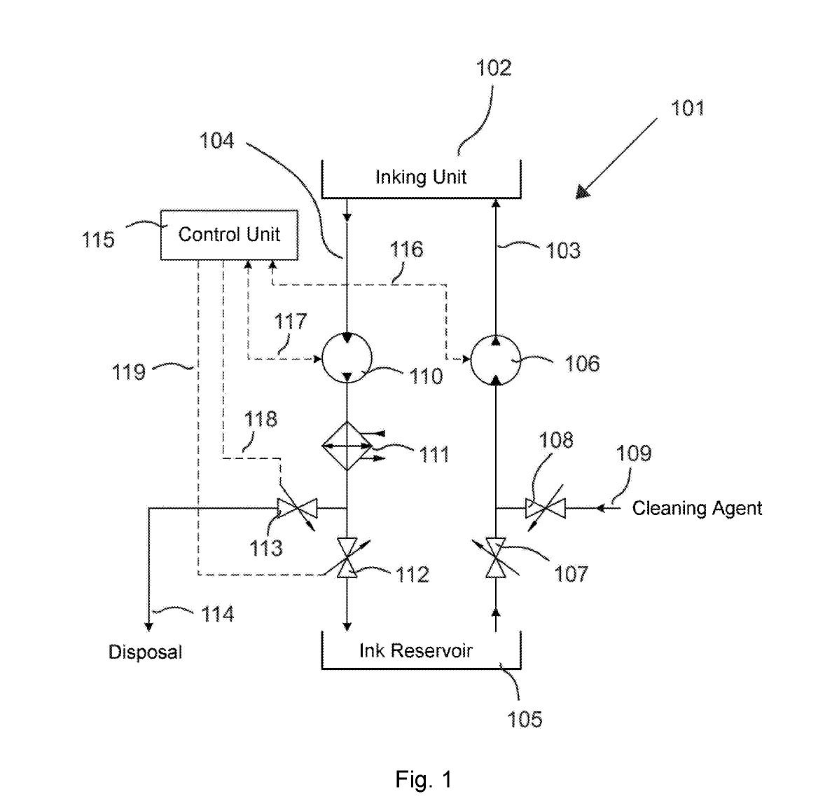

FIG. 1 shows the ink circuit according to the present invention.

The ink circuit 101 according to the present invention is provided for operating an inking unit 102 of a flexographic printing press, wherein the inking unit 102 has an ink inflow 103 for providing ink which is ready for printing and an ink outflow 104 for transporting away excess ink.

The ink inlet 103 is supplied with ink by the ink reservoir 105 via the pump 106, the pump 106 being an air-driven double diaphragm pump. Valves 107 and 108 enable the ink inflow 103 and thereby also the entire inking unit 102 to be washed with a cleaning agent which is supplied via a point of access 109.

The ink outflow 104 transports excess ink out of the inking unit 102 via the pump 110, the pump 110 being an annular piston pump which is driven by an asynchronous motor. Such an annular piston pump is known also by the technical term “eccentric disc pump” and is described in European patent specification EP 0 834 016 B1.

Since the ink heats up as it passes through the annular piston pump 110, a heat exchanger 111 which cools the ink back down in order to prevent the ink from degrading as a result of excessive heating is provided downstream of the annular piston pump 110. The valves 112 and 113 enable fluid in the outflow to either be returned to the ink reservoir 105 or disposed via line 114.

A control unit 115 controls all the components of the inking unit, with FIG. 1 showing only the control lines of interest, 116, 117, 118 and 119.

The asynchronous motor is operated using so-called field-oriented control. A field-oriented control system, also called vector control system, consists of a rotational speed controller based on a secondary current controller. Instantaneous active and reactive current components are controlled. The motor values are saved, or optionally even automatically determined and adapted, in a motor model electronically stored in the converter. This has the advantage that there has to be no separate rotational speed measurement and feedback for controlling rotational speed and torque. Instead, the only value that is fed back for control is the instantaneous current. Based on the level of this current and its phase relation to the voltage, all of the required motor states (rotational speed, slip, torque and even thermal dissipation loss) can be determined.

Measuring the instantaneous current of the asynchronous motor of the annular piston pump 110 thus allows the torque of the motor and therefore the viscosity of the ink to be accurately determined. When changing printing jobs, this can be used to determine transitions between ink feeding and flow-through of cleaning agent in a simple and accurate manner, thereby also enabling the valves 112 and 113 to be precisely controlled. Overall, this enables the recycling quota of the valuable ink to be optimized and, as a result, changeover costs to be minimized.

1. An ink circuit of an inking unit of a flexographic or gravure printing press,
wherein the inking unit has an ink inflow for providing ink which is ready for printing and an ink outflow for transporting away excess ink,
wherein the ink inflow is operated by an inflow pump and the ink outflow is operated by an outflow pump, and
wherein the outflow pump is a pump which is driven by an electric motor.

2. The ink circuit according to claim 1, wherein the inflow pump is a pump which is driven by an electric motor.

3. The ink circuit according to claim 1, wherein the pump is an annular piston pump.

4. The ink circuit according to claim 3, wherein a heat exchanger is connected downstream of the annular piston pump, to cool the ink.

5. The ink circuit according to claim 1, wherein the viscosity of the ink conveyed by the pump is determined according to the motor state of the electric motor.

6. The ink circuit according to claim 1, wherein the electric motor is an asynchronous motor.
